(19) United States
(12) Patent Application Publication
(10) Pub. No.: US 2008/0278486 A1
(43) Pub. Date: Nov. 13, 2008

(54) Method And Device For Selecting Level Of Detail, By Visibility Computing For Three-Dimensional Scenes With Multiple Levels Of Detail

(75) Inventors: Jerome Royan, Rennes (FR); Loic Bouget, Rennes (FR); Romain Cavagna, Rennes (FR)

Correspondence Address: LOWE HAUPTMAN HAM & BERNER, LLP, 1700 DIAGONAL ROAD, SUITE 300, ALEXANDRIA, VA, 22314, US

(73) Assignee: FRANCE TELECOM, Paris (FR)

(21) Appl. No.: 11/814,810

(22) PCT Filed: Jan. 23, 2006
(86) PCT No.: PCT/FR2006/000164

§ 371 Date: Mar. 28, 2008

(30) Foreign Application Priority Data
Jan. 26, 2005 (FR) 0500814

(51) Int. Cl. G06T 15/00; G06T 17/00

(52) U.S. Cl. 345/420

(57) ABSTRACT

The present invention sets out to combine a calculation of visibility from a viewpoint, with the selection of a level of detail for each of the nodes in a tree representing the geometry of the objects in a scene, so as increase the level of geometric detail of the visible objects and to reduce this level for all the obscured objects.

### RELATED APPLICATIONS

The present application is based on, and claims priority from, French Application Number 05/00814, filed Jan. 26, 2005, and PCT Application Number PCT/FR06/000164, filed Jan. 23, 2006, the disclosures of which are hereby incorporated by reference herein in their entireties.

### FIELD OF THE INVENTION

The present invention concerns a method and device for displaying objects making up a scene. The technical field of the present invention is that of synthesis imaging and more particularly that of virtual navigation within a three-dimensional digital scene.

### BACKGROUND ART

Virtual navigation in a three-dimensional scene consists of running through the digitised scene either at ground level or at a predetermined altitude. In the latter case flight over the scene is spoken of. In order to navigate virtually in a scene, whether this be at ground level or at a predetermined altitude, a display method is generally used to determine a three-dimensional representation of each of the objects that is visible to an observer situated at a viewpoint. Such a display method includes a step of calculating the three-dimensional geometrical rendition of each of the objects in the scene that are visible to the observer and a step of displaying the rendition thus calculated.

The step of calculating the geometrical rendition of the three-dimensional representation of objects poses various problems relating to the fact that all the calculations necessary to obtain an acceptable visual rendition of each of the objects in a scene is all the more expensive in terms of calculation power when the models represent the geometry of these objects with more precision and the number of objects in the scene is high. Thus, in order to reduce this calculation cost, one solution consists of limiting the calculation of the geometrical rendition of the scene solely to the calculation of the rendition of the objects that are visible, that is to say to the calculation of the geometry solely of the objects that are contained inside a pyramid of view of the observer where the origin is determined by the viewpoint of this observer, the orientation by the direction in which he is looking and the divergence angle by his angle of view.

In the case of an overflight of a scene, the step of calculating the geometrical rendition of the objects that are visible in a scene includes, for each of the objects in the scene situated in a pyramid of view, a step of selecting the level of geometrical detail, among several, with which this object will be represented, for example according to the distance of the object with respect to the viewpoint. Thus the objects that are closest to the viewpoint are represented with a finer level of detail than the objects that are distant from it. This selection of the level of detail among several levels is not detrimental to the quality of the rendition of the objects in the scene since the finest geometrical details of the furthest away objects are not in fact perceptible precisely because of their distance.

In the case of navigation at ground level, an object that is contained in a predetermined pyramid of view is considered to be potentially visible but, in fact, is actually visible only if it is not obscured by an object situated between it and the viewpoint. The calculation of the geometrical rendition therefore begins, for each object in question contained in a predetermined pyramid of view and therefore potentially visible, by a step of determining the visibility of this object followed by a step of determining the level of detail with which it will be represented geometrically. The level of detail is generally determined according to the visibility. Thus obscured objects, often the most distant, are represented with a coarse level of detail while the objects actually visible, generally also the closest to the viewpoint, are depicted by a fine level of detail.

As has just been seen, whether for navigation at ground level or overflying a scene, it is necessary for any one object to be able to have several geometrical representations in a hierarchy according to the level of geometrical detail required at a given moment, that is to say several geometrical renditions obtained from several models representing this object respectively at different geometrical levels of detail.

For this, the scene is generally represented digitally by a tree of nodes, each of which references one of the geometrical representations of an object or, in other words, one of the models of this object. A model referenced by a child node of another node, referred to as the parent node, has a finer level of detail than the model of the object referenced by this parent node. This tree thus supplies a multilevel geometrical representation of details of each of the objects in a scene.

In addition, a model referenced by a child node of a parent node is delimited, geometrically, by the model referenced by this parent node. This makes it possible to be able to term visible a part of the scene represented by a parent node as soon as all the parts of this scene represented by its child nodes are visible.

In a client/server environment, a server terminal transmits, in streaming mode, the data relating to a scene to a client terminal for its display so that an observer can navigate in it. Transmission in streaming mode makes it possible for this navigation not to be disturbed by latency times due to the complete loading of all the data relating to this scene. Thus, using a multilevel representation of details of a scene, the volume of data to be transmitted by such a server terminal can be adapted to the capacity of the network used, thus allowing fluid display of the rendition of the objects in the scene in the distant display terminal.

The problem that is therefore proposed is to define a calculation of the geometrical rendition of the visible objects of a scene modelled by a multilevel representation of details, with a view to obtaining an exceptional rendition of these objects whilst minimising the volume of data necessary for defining this geometrical rendition.

In the prior art, this problem is resolved by a step of determining the visibility of each of the objects in the scene and a step of selecting the level of detail required for the rendition. The visibility of each of the objects is determined from the model of this object at the finest level of detail and the level of detail is selected for each visible object thus identified. Serialising the determination of the visibility and then selecting the level of detail requires a large amount of calculation time while this determination of visibility, having to be updated at each movement of the observer, should be very rapid so that the updating of the rendition of the scene is made without any waiting time.

Other techniques allowing a change from overflying a scene to navigating this scene at ground level consists of partitioning the navigable space of this scene into cells, referred to as view cells, and determining, for each of these view cells, a set of potentially visible objects. In a client/server environment, the display terminal transmits the position of the observer to the server terminal, which then determines the corresponding view cell from the viewpoint derived from the said position received as well as the objects visible in this cell according to this viewpoint and then transmits to the display terminal the data relating to the visible objects. The determination of the visibility that is then made by the server is thus greatly reduced in terms of calculation costs because the server considers only a subset of the objects of the scene. However, the server terminal fulfils the role of a structured database that responds to requests. This type of server terminal therefore requires a storage volume that is all the larger, the greater the complexity of the scene, and must be able to support a number of simultaneous connections relating to the number of observers currently navigating in this scene.

The techniques of selecting levels of detail that are found in the prior art are based on psychovisual criteria. For example, one of these criteria is the visual importance granted to an object defined as relating to the number of pixels covered by a projection of this object onto a picture plane (the display screen of the observer). Thus this projection forms the surface that is directly related to the size of the object and to its distance with respect to the viewpoint of the observer.

Another one of these psychovisual criteria is the visual importance granted to an object defined by its velocity in the image plane. Thus the more quickly an object moves in an image plane, the more its geometrical complexity can be reduced.

The visual importance of an object can also be defined by an observer focusing on a specific area of the image plane, for example the centre of this plane. In this case, the object situated in the middle of this image plane need a finer level of detail.

Finally, not all the objects in a scene have the same visual importance. For example, in the case of an urban scene, the object relating to a monument in the scene has a greater visual importance than an object relating to a dwelling and therefore should be displayed as a priority with a finer level of detail.

No approach of the prior art makes it possible to determine the visibility in real time of each object in a scene solely from the model of this object referenced by a node that is used for representing the scene whereas this type of approach would have a certain advantage in a client/server environment. This is because such an approach would avoid all the data relating to the finest models of each object in the scene being transmitted to the display terminal.

In addition, the visibility of each object should be determined from a region situated around a viewpoint rather than solely from a viewing pyramid, so that this determination would remain valid for any viewpoint situated in this region. This would make it possible to limit the number of updates necessary for determining the visibility of the objects in the scene and to anticipate future movements (translation or rotation around the viewpoint) of the observer.

### SUMMARY OF THE INVENTION

One of the aims of the present invention is to combine a step of determining the visibility of each object in a scene effected for a circular region centred on a viewpoint and a step of selecting a level of detail for each of the nodes in a tree representing the geometry of the objects in a scene, so as to increase the level of geometric detail of the visible objects, and to reduce this level for all the obscured objects.

To this end, a method of displaying a scene consisting of a plurality of objects, the said method comprising a step of displaying a model of each visible object in the said scene among several models of the said object at different levels of detail, is characterised in that it comprises:

a) a step of determining the visibility of the objects, a model of which belongs to a set of models intended for the display of the said scene, referred to as active models,
b) a step of replacing, in the said set of active models, each model of one or more objects determined as being visible by the model or models of the same object or objects at a higher level of detail,
c) a step of replacing, in the said set of active models, the active models of objects determined as being obscured and having a replacement model at a lower level of detail, by the latter.

steps a) to c) being implemented iteratively as long as a stop condition is not satisfied.

According to another embodiment of the present invention, the above display method is characterised in that, at step b), for each model of one or more objects determined as being visible, the method comprises a step of sending to a server terminal a request to obtain the model or models of the same object or objects at a higher level of detail and a step of receiving the said model or models.

This embodiment is advantageous in the case of a display system in a client/server environment since it allows optimisation of the bandwidth of the network connecting the client terminal to the server terminal, and sending the geometry of the scene only at the explicit request of the client terminal.

According to another embodiment of the present invention, the method of displaying a scene, of the type where the models of the objects of the said scene are respectively referenced by the nodes in a tree of nodes, a node in the said tree referencing a model having a level of detail lower than that of the model or models referenced by the child nodes of the said node, the active models being referenced by nodes referred to as active nodes, is characterised in that:

the said step a) consists of determining the visibility of the objects, a node of which belongs to a set of active nodes,
the said step b) consists of replacing, in the said set of active nodes, each node referencing a model of one or more objects determined as being visible by its child node or nodes,
the said step c) consists of replacing, in the said set of active nodes, the nodes of several objects secured by a replacement node determined from the nodes of the obscured objects.

This embodiment is advantageous since it avoids the manipulation of a large volume of data represented by the models of objects by manipulating only references on these models.

The present invention also concerns a device for displaying a scene comprising means for displaying a model of each visible object in the said scene among several models of the said object at different levels of detail, characterised in that it comprises:

a) means for determining the visibility of the objects, a model of which belongs to a set of models intended for displaying the said scene, referred to as active models,
b) means for replacing, in the said set of active models, each model of one or more objects determined as being visible by the model or models of the same object or objects at a higher level of detail,
c) means for replacing, in the said set of active models, the active models of objects determined as being obscured and having a replacement model at a lower level of detail, by the latter.

The present invention also concerns a system of displaying a scene comprising a server terminal and a display terminal, characterised in that:
the said display terminal includes an aforesaid display device as well as means for sending, to the said server terminal, a request to obtain at least one object model and means for receiving, from the said server terminal, the said model or models requested, and
   in that the said server terminal comprises:
   means for storing object models, means for receiving from the said display terminal a signal requested the obtaining of at least one object model, sent by the said display terminal,
   means for sending the model or models requested by the said display terminal.

The present invention also concerns a terminal for displaying a scene in a system comprising a server terminal and a display terminal, characterised in that it includes an aforesaid display device as well as means for sending, to the said server terminal, a request to obtain at least one object model and means for receiving, from said server terminal, the said model or models requested.

Finally, the present invention concerns a computer program stored on an information carrier, the said program containing instructions for implementing one of the above methods, when it is loaded into and executed by a display device.

It is advantageous that the determination of the visibility of the objects precedes the replacement of the active models of the visible objects and the replacement of the model of the obscured objects since thus these modifications of the level of detail require a limited calculation time because they relate to a reduced number of models. In addition, introducing a calculation of visibility on only part of the models of objects representing a scene makes it possible to determine the visibility of an object without needing to know the model of each object at a maximum level of detail. Thus this characteristic is particularly advantageous in the case of a display system in a client/server environment, since the client terminal, having only partial knowledge of the scene, can all the same calculate the visibility of an object from the model of this object that it has available.

According to one embodiment of the visibility calculation, step a) comprises at least the following sub steps:
establishing a list of active models ordered by increasing order according to the distance of these models, referred to as the depth, vis-à-vis the viewpoint of the observer, and then
iteratively for each node in the said list,
   determining the visible character of the said model referenced by the said node provided that its cylindrical perspective projection is not situated below the horizon of the said scene, the said horizon being defined by a set of arcs belonging to a cylinder centred around the said viewpoint and obtained by the minimum ordinate of the perspective projection of the highest part of the visible objects,
   in the case where the said projection is determined as being visible, modifying the said horizon so as to take account of the minimum ordinate of the highest part of the said model referenced by the said node.

Such a calculation of visibility of the objects in the scene is carried out in real time. In addition, this type of calculation is particularly advantageous since it makes it possible to anticipate the change in direction of view (rotation of the observer around the viewpoint), while also considering, during this calculation, the objects situated all around the viewpoint. Finally, it makes it possible to keep fluidity of a display system in a client/server environment even if the network conditions are not favourable since the visibility calculation can be anticipated when the system perceives that the observer will leave the position from which the last visibility calculation was updated.

Introducing the determination of an ordered list according to the depth is particularly advantageous since it makes it possible to increase first the level of detail of the objects closest to the viewpoint. Thus, in a display system in a client/server environment, the first data transmitted are the data making it possible to calculate the rendition of the objects closest to the viewpoint.

According to another embodiment of the visibility calculation, the model of an object being defined by an impression on the ground of this object and by the height of this object, the said cylindrical perspective projection of the model is defined according to a reference axis oriented from the viewpoint in a predetermined direction, by
the value of first and second angles, referred to as projection angles, with respect to the said reference axis, the said angles defining a cone, encompassing the said model, the origin of which is the viewpoint,
a maximum ordinate obtained by perspective projection of a prism erected from the impression on the ground of the said model, at the said height of the object,
the minimum depth of one of the points of the said impression on the ground with respect to the said viewpoint.

It is advantageous to determine the visibility of an object with respect to the horizon by considering the maximum ordinate of the perspective projection of the highest part of the object and to modify the horizon according to the minimum ordinate of this projection, since thus visibility calculation errors that might occur when an object is partially obscured by part of another object are avoided.

According to a variant of the modification of the horizon by the addition of an arc, the said reference axis is merged with the viewing axis of the observer and each arc of the said horizon is eroded.

It is advantageous to erode the arcs defining the contribution of a visible object to the definition of the horizon of the scene since thus the calculation of visibility makes it possible to anticipate the translation movements of the observer whose maximum amplitude is limited by the amplitude of the erosion of these arcs.

According to a variant of the replacement of the active model of the visible objects, step b) is implemented according to a priority given to each of the said visible active models.

It is advantageous to allocate a priority to the active models of visible objects so as to modulate the level of detail of the geometry of the objects according to a predetermined criterion. For example, the objects closest to the viewing axis are represented with a finer level of detail than the objects situated far from this axis.

The characteristics of the invention mentioned above, as well as others, will emerge more clearly from a reading of the following description of an example embodiment, the said description being given in relation to the accompanying drawings.

### BRIEF DESCRIPTION OF THE DRAWINGS

FIG. 1 is a block diagram of a device for displaying a scene according to one embodiment of the present invention.

FIG. 2 is a block diagram of a system for displaying a scene according to one embodiment of the present invention.

FIG. 3 is a diagram of the successive steps of an iterative method of displaying a scene according to a first embodiment of the present invention.

FIGS. 4a to 4b are diagrams illustrating the replacements of models of visible and obscured objects according to the embodiment of the present invention described in relation to FIG. 3.

FIG. 5 is a diagram of the successive steps of an iterative method of displaying a scene according to a second embodiment of the present invention.

FIG. 6a is a diagram of the successive steps of a visibility calculation according to an embodiment of the present invention described in relation to FIG. 3 or FIG. 5.

FIGS. 6b and 6c are diagrams of a cylindrical perspective projection of a 2.5D model of an object.

FIG. 7a is a diagram of the successive steps of a variant of the horizon arcs calculation described in relation to FIG. 6a.

FIGS. 7b to 7e are illustrations of the erosion of an arc.

FIG. 8a is a variant of one of the embodiments of the present invention or of one of the variants thereof.

FIG. 8b is an illustration of the priority calculation associated with an object model.

### DETAILED DESCRIPTION OF THE DRAWING

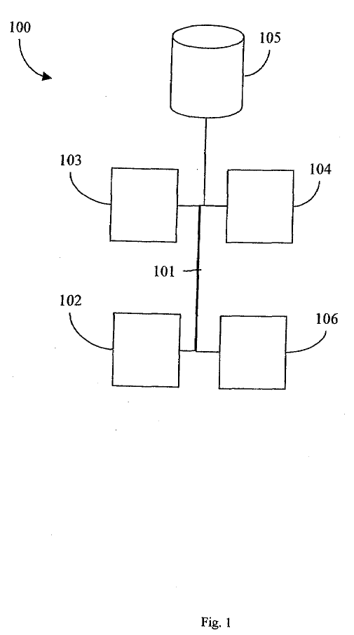

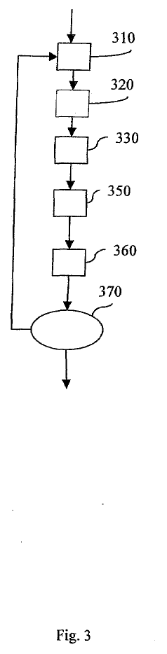

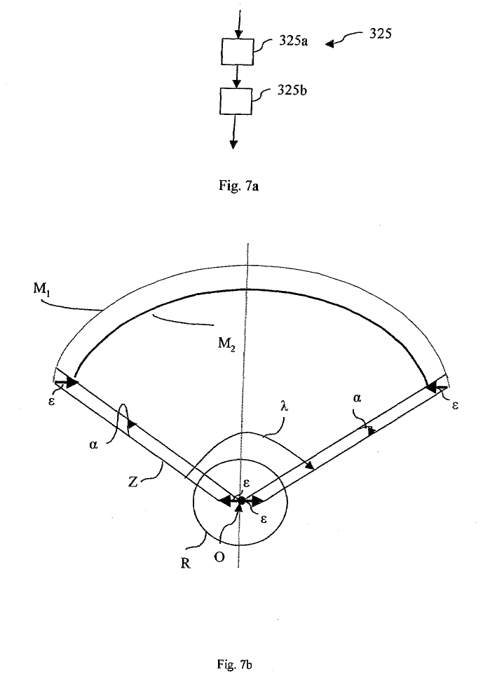

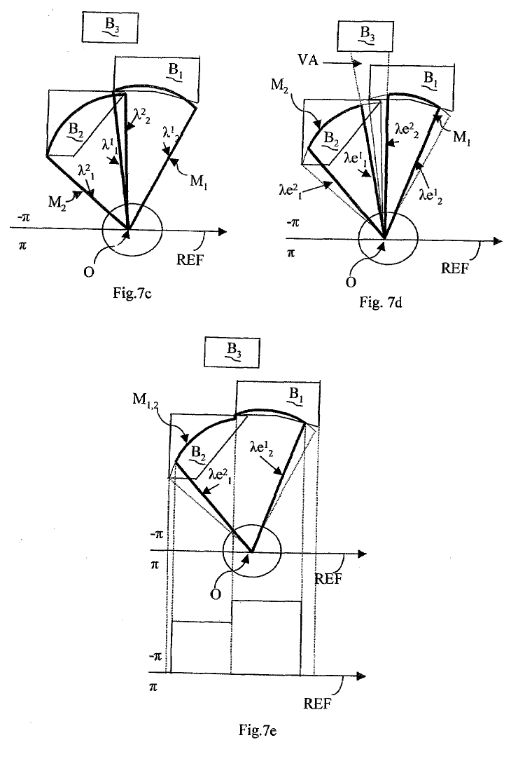

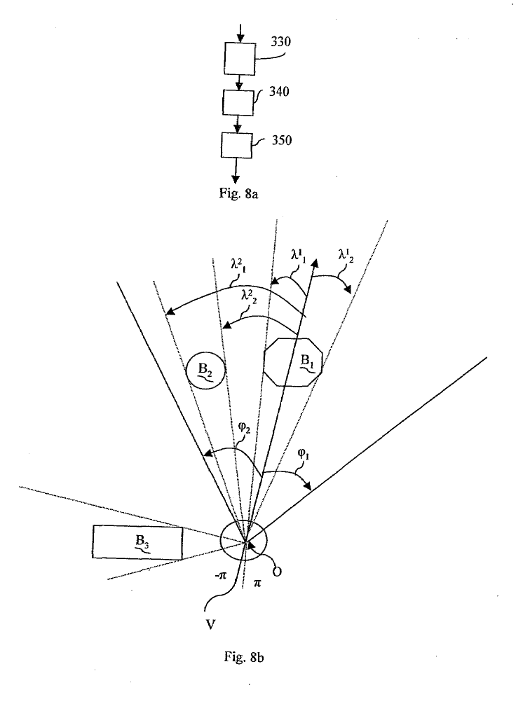

FIG. 1 is a block diagram of a device 100 for displaying a scene according to the present invention. This display device 100 is adapted to implement, for example by means of software that it incorporates, the steps of the display method according to an embodiment of the present invention described in relation to FIG. 3 or of one of its variants described in relation to FIGS. 7a and 8a. This display device 100 consists for example, non-limitingly, of an office computer of a user or a workstation. It comprises essentially a communication bus 101 to which there are connected a processor 102, a non-volatile memory 103, a random access memory 104, a database 105 and a man/machine interface 106.

The interface 106 comprises means for enabling a user to define a viewing pyramid and its means for displaying a three-dimensional digital representation of a scene according to a viewing window delimited by the viewing pyramid defined by the user. For example, and non-limitingly, the means for defining a viewing pyramid consist of an alphanumeric keyboard and/or a mouse of an office computer of a user associated with a software interface. The means for displaying a scene consist, for example and non-limitingly, of a screen of an office computer of a user.

The non-volatile memory 103 stores the programs and data allowing, amongst other things, the implementation of the steps of the method according to the present invention or one of the variants thereof. More generally, the programs according to the present invention are stored in storage means that can be read by a processor 102. These storage means are integrated or not into the display device 100 and may be removable.

The database 105 stores the data representing the geometry of a scene at various geometric detail levels. It can be read by a processor 102 and be removable.

When the communication device 100 is powered up, the programs according to the embodiment of the present invention or one of the variants thereof are transferred into the random access memory 104, which then contains the executable code and the data necessary for implementing this embodiment of the present invention or one of the variants thereof.

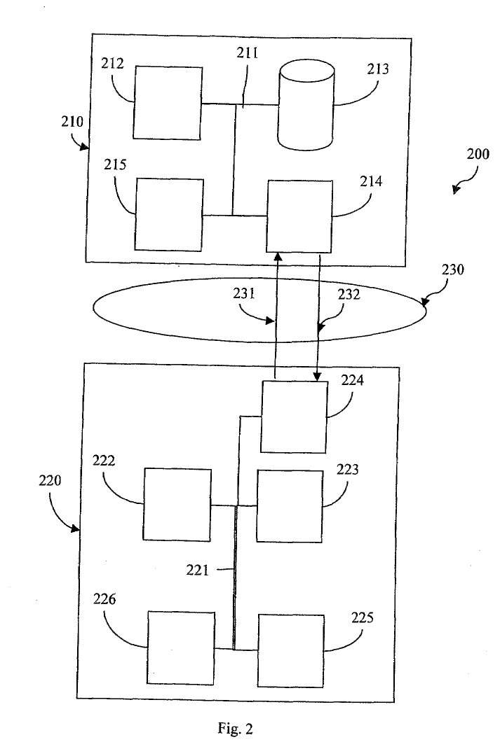

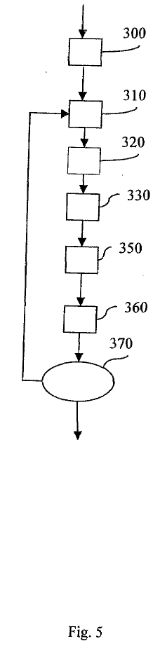

FIG. 2 is a block diagram of a system 200 for displaying a scene according to the embodiment of the present invention described in relation to FIG. 5 or one of its variants described in relation to FIGS. 7a and 8a. The system 200 comprises a communication terminal 210, referred to as a server terminal, and a communication terminal 220, referred to as a display terminal, connected to each other by a communication network 230, such as for example part of the internet or an intranet. The server terminal 210 is for example, and non-limitingly, an office computer of a user, or a server or of an internet or intranet network.

The communication terminal 210 is adapted to perform, using software, the steps of the embodiment of the present invention or one of the variants thereof. It comprises a communication bus 211 to which there are connected a processor 212, a random access memory 215, a database 213 and a communication interface 214.

The communication interface 214 is able to send a response signal 232 describing a geometric representation of part of a scene, to a communication terminal 220, and this following the reception of a request signal 231 sent by the said communication terminal 220.

The database 213 stores the data representing the geometry of a scene at various geometric detail levels. More generally, this storage means can be read by a microprocessor 212 and may be removable.

When the communication terminal 210 is powered up, the programs according to this embodiment of the present invention or of one of the variants thereof are transferred into the random access memory 215, which then contains the executable code and the data necessary for implementing this embodiment of the present invention or of one of the variants thereof.

The display terminal 220 is for example an office computer of a user. It is adapted to perform, using software, the steps of the embodiment of the present invention or of one of the variants thereof. It comprises a communication bus 221 to which there are connected a processor 222, a non-volatile memory 223, a random access memory 225, a man/machine interface 226 and a communication interface 224.

The man/machine interface 226 comprises means for defining a viewing pyramid and display means similar to those of the man/machine interface 106 of the device 100 described in relation to FIG. 1.

The communication interface 224 is able to send a request signal 231 to a communication terminal 210 and to receive a response signal 232 sent by the said communication terminal 210. To do this, the communication interfaces 214 and 224 are connected to each other by the network 230.

The non-volatile memory 223 stores the programs implementing this embodiment of the present invention or of one of the variants thereof, as well as the data for implementing this embodiment or one of the variants thereof.

In more general terms, the programs according to the invention are stored in a storage means. This storage means can be read by a processor 222. This storage means is integrated or not into the device and may be removable.

When the communication terminal 220 is powered up, the programs according to this embodiment of the present invention or of one of the variants thereof are transferred into the random access memory 225, which then contains the executable code and the data necessary for implementing this embodiment or one of the variants thereof.

FIG. 3 is a diagram of the successive steps of a method of displaying a scene according to a first embodiment of the present invention. According to this embodiment, the scene is depicted digitally by a node tree constructed in the following fashion.

Each node of this tree references a model among several models of at least one object. For example, each model used for the representation of an object is of the so-called “2.5D model” type known to persons skilled in the art. This type of model is obtained by projecting, onto a projection plane situated at a given altitude, the external envelope of an object and the external envelope of each of the internal spaces that the said object possibly includes. Thus a 2.5D model consists of an impression on ground that represents this projection, the value of the height of this object and the altitude of the projection plane. Thus the approximation of the three-dimensional representation of an object used, for example, for the display of this object by a display device 100 or by a display system 200 is obtained by the erection of a prism on the impression on the ground thus defined.

Each leaf node (a node not having a child node) in the tree representing a scene references a 2.5D model of a single object at a maximum definition level.

The 2.5D object model of the scene referenced by a parent node of at least one child node is obtained by simplification of the model or models of this object referenced by this child node or nodes. For example, in the case where the impression on the ground of objects is delimited by polygonal contour defined by the models referenced by child nodes from a number of tops, the impression on the ground of the model referenced by their parent node is delimited by a polygonal contour defined from a small number of tops.

Likewise, the models of objects referenced by several nodes can be fused into a single model, which is then referenced by their parent node. For example, the polygonal contour delimiting the impression on the ground of a model referenced by a parent node can be obtained by diffusion of polygonal contours defined by the models referenced by its child nodes. This fusion corresponds, for example, to a fusion of two adjacent objects.

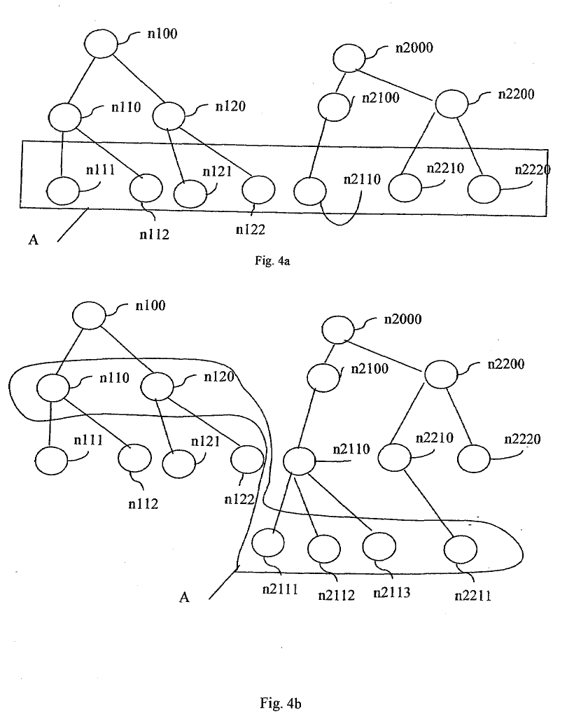

The method of displaying a scene represented by such a tree is illustrated by FIGS. 4a to 4b. As can be seen, this method is an iterative method that begins at an initialisation step 310 during which there is considered a set of nodes, referred to as active nodes, referencing models intended for displaying the said scene. Each model of this set is said to be an active model. At each step 310, the active nodes and the models that they reference are recovered, for example, from the database 105. For example, at the first iteration, only the root node of the tree can be considered to be an active node.

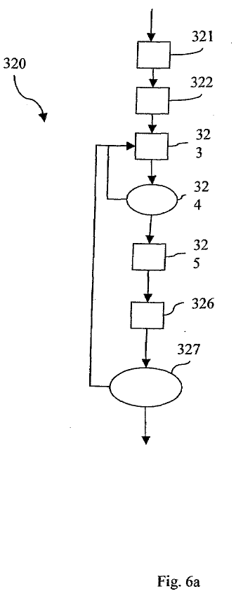

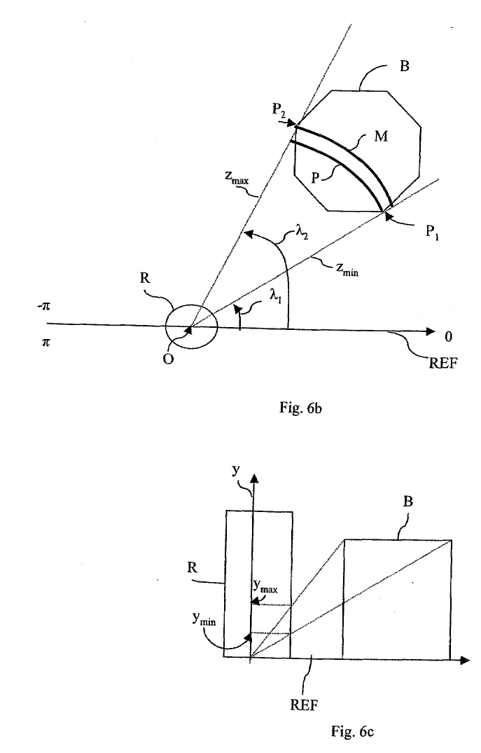

At step 320, the visibility of the objects in the scene represented by models referenced by the nodes of the said set of active nodes is determined, for example in accordance with the description given below in relation to FIG. 6a. Following this step, each object represented by a model referenced by an active node is considered either to be visible or as being obscured by a model of another object placed between it and the viewpoint.

At step 330, each node referencing a model of one or more objects determined as being visible is replaced, in the said set of active nodes, with its child node or nodes. For this purpose, the child nodes of each node in the tree referencing a model of visible objects and the models that they reference are recovered from, for example, a database 105. Once the child nodes and their models have been recovered, the node referencing a model of visible object loses its active character and each of its child nodes becomes active.

According to the example described in relation to FIG. 4a, the nodes n111, n112, n121, n122n, n2110, n2210 and n2220 are active and form a set A of active nodes. Assuming that the nodes n2110 and n2210 reference the models of visible objects. They lose their active character and their respective child nodes n2111, n2112, n2113 and n2211 become active.

At step 350, the nodes referencing several models of objects obscured by a replacement node determined from the nodes referencing these models of obscured objects are replaced in the said set of active nodes. For example, in the case where the replacement node is the parent node of these nodes referencing these models of obscured objects, referred to as child nodes by definition, these child nodes lose their active character and their parent node becomes active.

According to the example described in relation to FIG. 4a, assume that the nodes n111, n112, n121, n122 and 2220 reference models of obscured objects. The parents nodes n110 and n120 of the respective child nodes n111, n112 and n121, n122 then become active and their child nodes lose their active character (FIG. 4b). Likewise the node n2200 loses its active character. On the other hand its parent node n2200 does not become active because one of its children, in this case the node n2210, references a model of visible objects. In this way, the obscured objects are no longer considered in a new iteration of the method, in this way reducing the calculation cost of the rendition of this scene, which will be limited solely to considering the visible objects.

Step 350 is followed by step 360, which displays the rendition of the three-dimensional representation of the scene using, for example, at least one of the means 106 of the display device 100. The three-dimensional representation of the scene is obtained by erecting the prism of the object model referenced by each of the nodes referencing an active model.

Step 370 is a step of checking the number of iterations of the method. This is because, following a cycle of steps 320 to 360, the geometry of the scene is rendered and displayed according to a given level of detail. By reiterating this method, the representation of the visible objects of the scene will be rendered with a higher level of detail since each model of visible objects referenced by an active node will be replaced by the models referenced by the child nodes of each of these active nodes. However, this number of iterations is limited by the depth of the tree, that is to say by the maximum level of detail of the geometry of each of the visible objects represented by the model referenced by a leaf node.

According to a variant of this embodiment, the number of iterations can be limited by a maximum level of detail of the geometry of the predetermined scene, for example by a user. In the case where the maximum number of iterations is not reached, step 370 is followed by the previously described step 310, which once again considers a set of active nodes in the tree. The method stops as soon as this number of iterations is reached.

FIG. 5 is a diagram of the successive steps of an iterative method of displaying a scene according to a second embodiment of the present invention. According to this embodiment, the iterative method of displaying a scene is implemented by a display system 200 as described previously. This method begins with a step 300 of recovering the root node of the node tree and the model that it references, by sending a request signal 231 to a terminal 210. The request signal 231 comprises at least one item of information for identifying this root node. For example, in a case where all the nodes in a tree are numbered by integer values, this information would be a number. Once the terminal 210 has received the request signal 231, this terminal 210 has found the model referenced by its root node and has formed a response signal containing this information, it sends a response signal to the terminal 220. The terminal 220, by means of the processor 222, stores the data received in a memory, for example the non-volatile memory 223. Step 300 is then followed by the steps 310 and 330 described above.

Step 330 is then followed by step 350, during which, for each child node to be recovered of a parent node, a request signal 231 is sent to the terminal 210. According to a variant, a single request signal is sent to recover all the child nodes and the models that they reference. This request signal comprises an item of information for identifying at least one of the child nodes to be recovered. For example, in the case where all the nodes in a tree are numbered by integer values, this information would be the number of the parent node. Once the terminal 210 has received the request signal, once this terminal has found the model of the object referenced by at least one of the child nodes of the visible node designated by the identification information received, and once the terminal has formed a response signal containing this information, this terminal 210 sends a response signal 232 to the terminal 220. The terminal 220, through the processor 222, stores these data received in a memory, for example the non-volatile memory 203, and the kinship relationships between each of these child nodes received vis-à-vis their parent node. Step 350 ends with the processing of these child nodes thus recovered, as described previously.

FIG. 6a is a diagram of the successive steps used for determining the visibility of each active object in the tree (step 320 in FIG. 3) according to one of the embodiments of the present invention described above. The visibility determination begins with a step 321 of initialising a horizon of the scene defined by the vision of the scene that an observer situated in a plane at a predetermined viewpoint would have. For example, in a case where each model of the scene is depicted by a model of the 2.5D model type, the said plane is a plane on which the impression on the ground of each object in the scene is defined, that is to say the plane on which the navigation on the ground of the scene is carried out. A horizon of the scene is defined by a broken line consisting of arcs of a circle parallel to the plane.

Each of these arcs defines the top part of an object visible from the viewpoint. Such an horizon is initialised during step 321 considering a horizon with no arcs.

Step 321 is followed by a step 322, which forms a list of the active nodes and orders this list according to the distance to the viewpoint, for example minimum, from the object model referenced by each of these active nodes. This distance is called the minimum depth of the object. The visibility determination is carried out in the order of the list of the active nodes, the first active node considered being the node that references the model of the object closest to the viewpoint.

Step 322 is followed by step 323, which considers a current node in the list of active nodes and calculates the cylindrical perspective projection of the model referenced by this current node. In the case where each object is represented by a model of the 2.5D model type, the three-dimensional digital representation of the model of an object will be obtained by erecting a prism, by a predetermined height from the impression on the ground of this object (step 360). Thus the perspective projection of the prism of a model of an object onto a cylinder R centred at O defines each arc of the horizon of the scene.

FIGS. 6b and 6c show the cylindrical respective projection of an object defined on a three-dimensional parametric space [−π;π], [−∞;+∞] [0;+∞] by two projection angles λ1 and λ2, a depth Z and an ordinate y defined orthogonally with respect to the plane. The parametric space is defined by a viewpoint O of a plane comprising a reference axis REF. The project angles (λ1, μ2) are defined, with respect to the reference axis REF, by two straight line segments connecting respectively the points (O, P1) and (O, P2). The points P1 and P2 are carried by planes tangential to the prism of the object comprising the point O. The cylindrical perspective projection of an object is, by definition, defined by these two projection angles, the minimum depth Zmin defined by the minimum distance between the point O and one of the two points P1 and P2, and the minimum ordinate Ymax corresponding to the maximum height of the perspective projection of the object onto the cylinder R. It can be noted that the calculation of the cylindrical perspective projection of an object is not restricted to being applied to the objects that are situated in a viewing pyramid but on the contrary is applied to any object in the scene, since the model of this object is referenced by a node in the list of active nodes.

Step 323 is followed by step 324, which tests the visibility of the projection calculated at the previous step vis-à-vis the current horizon. For this purpose, it is tested whether the ordinate Ymax of the perspective projection is greater than the ordinate of the arc that is situated in the cone delimited by the projection angles λ1 and λ2 and whose origin is situated at the viewpoint O. In the negative, the current node is considered to be obscured, a new current node in the ordered list is considered and step 324 is then followed by the previously described step 323.

In the affirmative, the object or objects represented by the model referenced by the current node are considered to be visible and step 324 is followed by a step 325 that determines the arc of this model that will contribute to the definition of the horizon of the scene. In the case where each object is represented by a model of the 2.5D model type, the arc of the model of an object B is obtained by cylindrical perspective projection of this object onto the three-dimensional parametric space described previously. The arc M of the model and the object B is defined by the projection angles λ1 and λ2, by the maximum object depth Zmax and by the minimum ordinate Ymin.

Step 325 is followed by a step 326, which updates the horizon of the scene in terms of y adding the arc M thus calculated. For this, the arc of the horizon that is situated in the cone delimited by the projection angles λ1 and λ2 defining the arc M is replaced by this arc M, which is parallel to the plane and is of ordinate equal to Ymin.

Step 326 is followed by step 327, which tests whether all the active nodes in the list of active nodes have been considered. In the negative, a new active node in this list is considered and step 327 is followed by the previously described step 323. In the negative, the visibility determination stops.

FIG. 7a is a diagram of the successive steps of a variant of the step of determining an arc contributing to the definition of the horizon of the scene (step 325) described in relation to FIG. 6a. Once the arc of a model referenced by a node of a visible object has been calculated at step 325a, in a similar manner to the calculation carried out during step 325 of FIG. 6a, the arc is eroded by a value α as shown in FIG. 7b. This erosion makes it possible to anticipate the translation movements of an observer. This is because it should be assumed that an arc delimits the top part of a mask M1 of an object extending from this arc as far as the plane, and which obscures any object situated behind it. As soon as the observer moves perpendicular to the median axis of this mask M1 by value ε, an object previously obscured, since it is behind the mask M1, may become visible so that a new determination of the mask must be made. In order to avoid having to recalculate this mask, it has been demonstrated that by eroding the mask M1 by an erosion value α defined by the following equation the eroded mask M2 does not have to be recalculated since the amplitude of the movements of the observer does not exceed ε.

$$α = arc cos ( \frac{2 \cdot {Z}^{2} ɛ ( ɛ - Z \sqrt{1 - cos α} )}{2 \cdot Z \cdot \sqrt{{ɛ}^{2} + {Z}^{2} - α \cdot Z \cdot \sqrt{1 - cos α}}} )$$

In practice, only the arc delimiting the top part of the mask is eroded. It is advantageous to erode the mask of a visible object before it is introduced into the horizon of the scene since thus the visibility calculation makes it possible to anticipate the translation movements of the observer, the maximum amplitude of which is limited by the degree of erosion of the mask. However, the erosion of the mask of two adjacent objects gives rise to an overestimation of all the visible objects, and hence the need to merge the eroded masks of adjacent objects, that is to say in practice to merge the arcs delimiting the top part of these masks, as illustrated by FIGS. 7c to 7e.

FIG. 7c depicts two visible objects B1, B2 and an object B3 obscured by the other two objects. The objects B1 and B2 are adjacent and their respective masks, M1 and M2, defined respectively by their angles (λ¹₁,λ²₁) and (λ¹₂, λ²₂), are not eroded. FIG. 7d shows the same objects in the case where the masks M1 and M2 have been eroded. The mask M1 is then represented by (λe¹₁, λe²₁) and the mask M2 by (λe²₁, λe²₂). In this case, as can be seen in FIG. 7d, the object B3 becomes visible because of the zone VA revealed by the erosion of the masks.

FIG. 7e shows the mask of the objects B1 and B2 obtained by merging the masks M1 and M2. The ordinate of the merged mask can therefore have several values defined by the ordinates of the mask making it up in the case where these masks correspond to objects with different heights.

FIG. 8a shows a variant of one of the embodiments of the present invention or one of its variants described previously. According to this variant, a step 340 is inserted between the steps 330 and 350 described previously. During step 340, a priority value is associated with each of the visible objects according to the position of this object vis-à-vis a predetermined viewing pyramid. Step 350 then consists of first considering the objects that have a high priority and subsequently considering the objects considered to have a lower priority. The determination of the priority value associated with the visible object begins with the calculation of an angle value θ according to the values of the angles λ₁ and λ₂ of the cylindrical perspective projection of this object, by:
θ=0 if (λ₁<0 and λ₂>0)
θ−min(∥λ₁,∥λ₂∥) otherwise.

The priority value is then determined, in relation to FIG. 8b, in the following manner:

If φ₁<θ<φ₂, then the priority P=a.∥θ∥+b, a being a negative integer value and b an integer value,

$$P = exp ( \frac{c}{‖ θ ‖} )$$

otherwise
with φ₁ and φ₂ defining the extreme values of the cylindrical perspective projection of the viewing pyramid. It can be noted that, according to this variant, the reference axis REF is merged with the viewing axis V.

In the example given by FIG. 8b, a high priority will be associated with the object B1 since it is situated on each side of the viewing axis. A lower priority is associated with the object B2. The object B3 is not considered by the priority calculation since it is not situated in the viewing pyramid.

1. Method of displaying, in a client/server environment, a scene having a plurality of objects, said method comprising:
(a) displaying on a display terminal a model of each visible object of said scene amongst several models of said object at different levels of detail, characterised in that it comprises:
(b) determining, by using the display terminal, the visibility of the objects, a model belonging to a set of active models intended for displaying the scene,
(c) replacing, by the display terminal, in the set of active models, each model of one or more objects determined as being visible by the model or models of the same object or objects at a higher level of detail, following a step of sending to a server terminal a request to obtain the model or models of the same object or objects at a higher level of detail as well as a step of receiving the model or models,
(d) replacing, by the display terminal, in the said set of active models, the active models of objects determined as being obscured and having a replacement model at a lower level of detail, by the latter, and
performing steps (b) to (d) iteratively until a stop condition is satisfied.

2. Method of displaying a scene according to claim 1, of the type where the models of the objects of the said scene are respectively referenced by the nodes in a tree of nodes, a node in the said tree referencing a model having a level of detail lower than that of the model or models referenced by child nodes of the said node, the active models being referenced by nodes referred to as active nodes wherein:
the step (b) includes determining the visibility of the objects, a node of which belongs to a set of active nodes,
the step (c) includes replacing, in the set of active nodes, each node referencing a model of one or more objects determined as being visible by its child node or nodes,
the step (d) includes replacing, in the set of active nodes, the nodes of several objects secured by a replacement node determined from the nodes of the obscured objects.

3. The display method of claim 1 wherein step (b) comprises the following sub steps:
establishing a list of active models ordered by increasing order according to the distance of these models, referred to as the depth, vis-à-vis a viewpoint of an observer, and then
iteratively for each node in the said list:
determining the visible character of the model referenced by the node if its cylindrical perspective projection is not situated below the horizon of the scene, the horizon being defined by a set of arcs belonging to a cylinder centred around the viewpoint and obtained by a minimal ordinate of the perspective projection of the highest part of the visible objects,
if the projection is determined as being visible, modifying the horizon to take account of the minimum ordinate of the highest part of the model referenced by the node.

4. Display method according to claim 3, wherein the model of an object is defined by an impression on the ground of this object and by the height of this object, and defining the cylindrical perspective projection of the model according to a reference axis oriented from the viewpoint in a predetermined direction, by
the value of first and second angles, referred to as projection angles, with respect to the reference axis, the said angles defining a cone, encompassing the model, the origin of which is the viewpoint,
a maximum ordinate obtained by perspective projection of a prism erected from the impression on the ground of the model, at the height of the object,
the minimum depth of one of the points of the impression on the ground with respect to the viewpoint.

5. Display method according to claim 4, further including merging the reference axis with the viewing axis of the observer, wherein each arc of the horizon is eroded.

6. The display method according to claim 4, further including merging the reference axis with the viewing axis of the observer, and the step (c) is performed according to a priority given to each of the visible active models.

7. A device for displaying a scene comprising display arrangement for displaying a model of each visible object in the scene among several models of the said object at different levels of detail,
the display arrangement comprising a processing arrangement for:
(a) determining the visibility of the objects, a model of which belongs to a set of models intended for displaying the scene, referred to as active models,
(b) replacing, in the set of active models, each model of one or more objects determined as being visible by the model or models of the same object or objects at a higher level of detail, the replacing portion of the processing arrangement being arranged for (i) sending, to a server terminal, a request to obtain the model or models of the same object or objects at a higher level of detail, and (ii) receiving from the terminal the model or models required,
(c) replacing, in the set of active models, the active models of objects determined as being obscured and having a replacement model at a lower level of detail, by the latter.

8. System for displaying a scene comprising a server terminal and a display terminal, the display terminal including a display device according to claim 7, the server terminal comprising:
a storage arrangement for storing object models, a receiver arrangement for receiving from said display terminal a request signal for obtaining at least one object model, sent by the said display terminal, and
a transmitter arrangement for sending the model or models requested by the said display terminal.

9. Computer program stored on an information medium, the program including instructions for causing a processor arrangement including a display to perform the method of claim 1.
